(19) United States
(12) Patent Application Publication
(10) Pub. No.: US 2008/0022313 A1
(43) Pub. Date: Jan. 24, 2008

(54) Program table generator and a method for quickly displaying a program table in response to user's request

(75) Inventor: Kiwamu Yoshioka, Saitama (JP)

Correspondence Address: VENABLE LLP, P.O. BOX 34385, WASHINGTON, DC, 20043-9998, US

(73) Assignee: Oki Electric Industry Co., Ltd., Tokyo (JP)

(21) Appl. No.: 11/822,654

(22) Filed: Jul. 9, 2007

(30) Foreign Application Priority Data
Jul. 10, 2006 (JP) 2006-189009

(51) Int. Cl. G06F 13/00; H04N 5/445; G06F 3/00

(52) U.S. Cl. 725/58; 725/39; 725/50

(57) ABSTRACT

In a set top box (STB), from a memory, program information is read out which corresponds to request time or a request time zone designated by an operation controller. A display controller generates display data of a program table listing broadcast programs. After generating the display data, a time span of predetermined time duration for saving is set, which includes the request time or time zone, as designated by an operation controller. A time zone in this time span for saving, for which the program information is not stored in the memory, is detected by a data acquisition controller. The program information of the so detected time zone is acquired from outside by a network interface circuit, and stored in the memory. The program information thus stored will be read out and displayed on a monitor display via a display controller and a display output unit.

### BACKGROUND OF THE INVENTION

1. Field of the Invention

The present invention relates to a program table generator and a method therefor. More particularly, the present invention relates to a program table generator for use in a broadcast receiver set, such as a broadcast watching and/or listening terminal device or a video recorder, for producing data of program table display to be displayed in the form of program table on a display device in accordance with electronic program guide (EPG) information on on-air programs, and a method for generating such a program table.

2. Description of the Background Art

Conventionally, broadcast watching and/or listening terminals, such as a set top box (STB), and video recorders, such as an HDD (Hard Disc Drive) recorder or a DVD (Digital Video Disc) recorder, are adapted for displaying a program table by receiving EPG information on broadcast channels, program contents and the start and end time of programs from outside, temporarily storing the so acquired information in its internal memory, and subsequently displaying it on its display screen in the form of program table. For detailed information, reference is to be made to the Japanese Patent Office website >Resources Chamber (other reference information)>Collection of Standard Techniques (hyoujun_gijutsu)>Bi-directional Moving Picture Communication Techniques>Basic Services of 1-1-1 Indexing/Metadata Editing, 1-1-1-8 TV Anytime (Search & Navigation), of which URL on the Internet is <http://www.jpo.go.jp/shiryou/s_sonota/hyoujun_gijutsu/bid irectional_video/111_{—}08.html>, browsed on Jun. 19, 2006. Reference is also made to the Japanese Patent Office website >Resources Chamber (other reference information)>Collection of Standard Techniques (hyoujun_gijutsu)>Bi-directional Moving Picture Communication Techniques>1-1-1 Indexing/Metadata Editing, 1-1-1-9 Various Packagings of TV Anytime system, of which URL on the Internet is <http://www.jpo.go.jp/shiryou/s_sonota/hyoujun_gijutsu/bid irectional_video/111_{—}09.html>, browsed on Jun. 19, 2006.

The user may manipulate, e.g. a pointing device, in accordance with such displayed information to thereby act on individual programs for checking the program information or booking programs to be watched or recorded.

Typical ones the conventional ways of acquiring EPG information from outside are broadcasting of data of EPG information, and downloading of EPG information from a web server. EPG information to be downloaded is of an encoded form. For example, EPG information is encoded into an XML (eXtended Markup Language) form based on the TV-Anytime vocabulary. The information thus encoded may further be binary-encoded. For detailed information, reference is made to the Japanese Patent Office website>Resources Chamber (other reference information)>Collection of Standard Techniques (hyoujun_gijutsu)>Bi-directional Moving Picture Communication Techniques>1-7 Contents Selection, 1-7-2 Electric Program Guide, of which the URL on the Internet is <http://www.jpo.go.jp/shiryou/s_snota/hyoujun_gijutsu/bidi rectional_video/17_{—}2.html>, browsed on Jun. 19, 2006. Reference is also made to the Japanese Patent Office website >Resources Chamber (other reference information)>Collection of Standard Techniques (hyoujun_gijutsu)>Bi-directional Moving Picture Communication Techniques>1-7 Contents Selection, 1-7-4 Program Array Information Send-Out System, of which the URL on the Internet is <http://www.jpo.go.jp/shiryou/s_sonota/hyoujun_gijutsu/bid irectional_video/17_{—}4.html>, browsed on Jun. 19, 2006.

In encoding EPG information in accordance with the TV-Anytime format, such a method could be thought of in which each program is associated with a single file containing its EPG information. Such an XML file having the EPG information stored therein is required to have the EPG information taken out in a terminal device or recorder therefrom. Moreover, if the information is binary-coded, it has to be decoded in the terminal device or recorder from file to file. The information is, when decoded, rendered into a form of EPG information which may be displayed on a display screen. EPG information may contain a variety of information for a program for reasons of the provider, so that the size of the file size could be as large as one kilobyte.

The terminal device or recorder usually displays EPG information for a user in the form of program table or schedule every single or plural channels. The displayed information may extend, e.g. for several days from the current day.

If EPG information is provided in such a form that each program is related with a single file, it is sufficient for displaying a program table that plural files are downloaded and respectively decoded. However, such decoding may impose significant processing load on a terminal device, such as STB box, having its CPU (Central Processing Unit) low in performance and its memory severe in storage capacity. For example, if 50 channels are available with each channel providing approximately 30 programs per day and the program information for two weeks is to be deployed on a memory of the terminal device or recorder, it is then necessary for the terminal device or recorder to decode 21,000 (=50×30×7×2) files. If the time involved in decoding a file is set to ca. 0.1 sec, then, in order for the terminal device or recorder, when booted, to develop all the data on the memory, it takes 32 min (=0.1 sec×21,000) even though the downloading time is disregarded. This means that, in a typical packaging, the boot time is correspondingly protracted, thus inconveniencing the user. On the other hand, if all files are downloaded in advance, the load on a disc memory is increased, which is deterrent to cost reduction of the terminal device or recorder.

A system could be considered in which EPG information is downloaded and decoded only when a program table has to be displayed on a user's request. In such a system, booting time may be reduced indeed, whereas the downloading and decoding are necessarily carried out in response to the user's request, thus retarding the reaction to the user's manipulation. Specifically, it would take three seconds (=0.1 sec×30 programs) in order to display the program table of a day per channel.

Meanwhile, such a use method is routinely used in which, when a user manipulates the operation unit or clicks the ‘next day’ button on the menu displayed on the screen to thereby browse a program table to scroll from the current day, to the next day and to the second next day (day after the next day), thus sequentially browsing the tables on the daily basis. Even with this use method, however, if it takes three seconds for each display operation until an intended program table is displayed, then the user may feel that the terminal device or recorder is not handy to use.

### SUMMARY OF THE INVENTION

It is an object of the present invention to provide a program table generator and a method for generating a program table whereby a program table for the time zone as requested by the user may be displayed relatively quickly.

In accordance with the present invention, there is provided a program table generator comprising a communication circuit for receiving the program information of an on-air program from outside, a memory operative in response to manipulation for saving the program information received by the communication circuit, an operation controller for designating a time domain representing a request time zone of a program table of the on-air program, a display controller for reading out the program information for the time zone designated to generate display data of the program table, and a data acquisition controller for setting, after the display data of the program table is generated, a time domain for saving showing a predetermined time length including the designated time zone of request. The data acquisition controller detects a time domain in the time domain for saving for which the program information is lacking in the memory. The data acquisition controller acquires the program information of the detected lacking time domain from outside through the communication circuit and saves the so acquired program information in the memory.

In accordance with the present invention, a method for generating a program table comprises a first step of receiving program information of an on-air program from outside to display display data of a program table in accordance with the program information, a second step of saving the program information received in a storage, a third step of designating a time span indicating a request time zone of the program table in response to manipulation, a fourth step of reading out the program table saved, for the designated request time zone, to generate the display data of the program table, a fifth step of setting, following the fourth step, a time domain for saving showing a predetermined time length including the designated time zone of request, a sixth step of detecting a time span in the time domain for saving during which the program information is lacking in the storage, and a seventh step of acquiring the program information of the detected lacking time domain from outside by a communication circuit and saving the acquired program information in the storage.

With the program table generator and the method for generating a program table, according to the present invention, the program information for on-air programs is received from outside by a communication circuit, and the program information so received is stored in a memory. An operation controller designates a time zone representing a request time zone of the broadcast program table in response to manipulation. The program information for the request time zone as designated by the display controller is read out from the memory to generate display data of the program table displaying the broadcast program table. After the display data of the program table is generated, a data acquisition controller sets a time zone representing a time domain of a predetermined duration for saving, inclusive of the designated request time zone. The data acquisition controller detects a time zone of the time domain for saving, the program information which lacks in the memory, and acquires the program information of the lacking time zone from outside via the communication circuit for saving in the memory. Upon the next user's manipulation, the program information corresponding to the newly designated display request time zone may be read out, so that the display data may readily be produced and output. In this manner, the program table, derived from the program information for the time zone as requested to be displayed by the user's manipulation, can quickly be displayed.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing an illustrative embodiment of a program table generator applied to an STB box according to the present invention;

FIG. 2 diagrammatically shows a typical example of a program table displayed on the display unit shown in FIG. 1;

FIGS. 3A and 3B are a flowchart useful for understanding the operation of the data acquisition controller shown in FIG. 1;

FIG. 4 is a flowchart useful for understanding the operation of the display controller shown in FIG. 1; and

FIGS. 5 and 6 are timing charts for illustrating the relationship between changes in a time window and a display request time zone in the STB box with EPG information stored in the memory shown in FIG. 1.

### DESCRIPTION OF THE PREFERRED EMBODIMENT

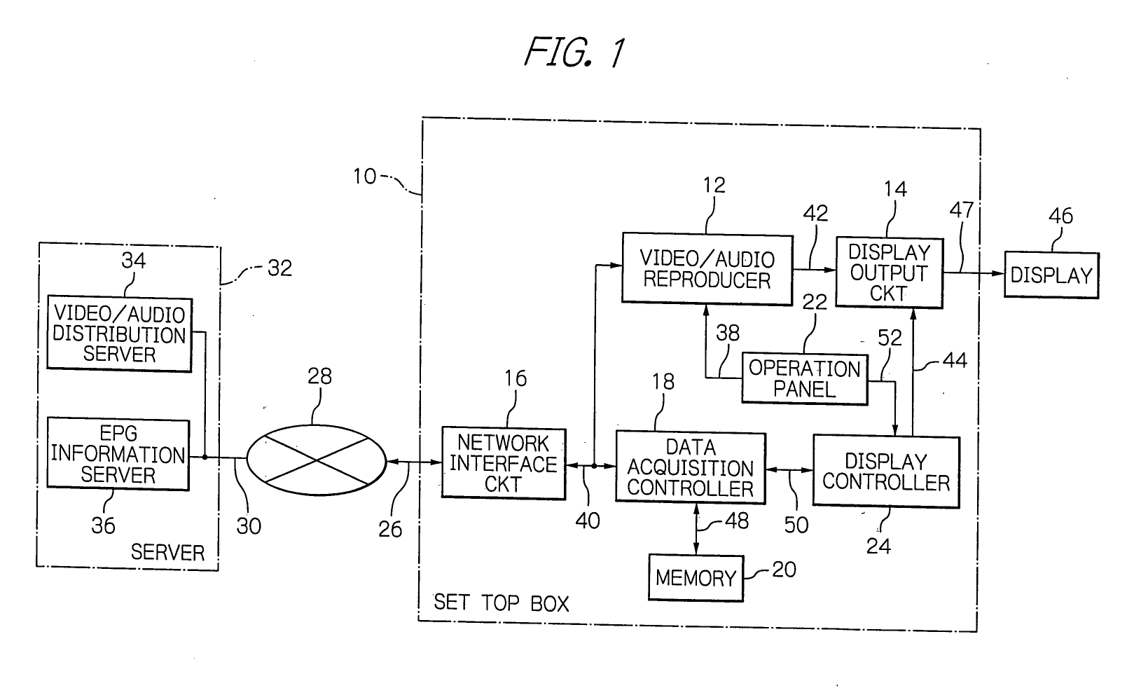

With reference to the accompanying drawings, a preferred embodiment of a program table generator according to the present invention will be described in detail. With reference first to FIG. 1, showing a preferred embodiment of a set top box (STB) 10 to which the present invention is applied, electronic program guide (EPG) information of broadcast programs is received from outside by a network interface circuit 16, and the so received information is saved in a memory 20. The STB box 10 includes an operation panel 22 which is adapted to be responsive to user's manipulation to specify a time span representing the request time zone of a program schedule or table. The STB box 10 further includes a display controller 24 for reading out the program information for the time span associated with the so specified request time zone from the memory 20 to generate display data of the program table listing on-air programs. The STB box 10 also includes a data acquisition controller 18 which is adapted for generating the display data of the program table, and thereafter setting a time domain defining a predetermined time duration for saving including the time span of the specified request time zone. The data acquisition controller 18 detects a time domain of a predetermined duration in the time domain for saving, during which there lacks program information from the memory 20. Program information corresponding to the time domain thus detected as destitute of program information is acquired from outside via the network interface circuit 16, and saved in the memory 20 over a connection 48. Upon an ensuing user's manipulation, the EPG information 48 corresponding to the domain of the request time zone to be displayed can be read out from the memory 20 so that an EPG video signal 44 may readily be formed and output. That is, a program table or list corresponding to the EPG information for the time domain requested to be displayed by the user's manipulation can be quickly displayed.

In the present illustrative embodiment, the program table generator of the present invention is applied to the set top box 10. Parts or components not directly relevant to understanding the present invention are not shown nor described. In the following description, signals are denoted by reference numerals of connection lines on which they appear.

With continuous reference to FIG. 1, the STB box 10 includes a video/audio reproducer 12, a display output circuit 14, the network interface circuit 16, data acquisition controller 18, memory 20, operation panel, or operation controller, 22 and display controller 24, which are interconnected as illustrated.

The network interface circuit 16 is connected via a communication line 26 to a telecommunications network 28, which is connected over a communication line 30 to a server 32. The server includes a video/audio distribution server 34 and an EPG information server 36. The video/audio distribution server 34 and the EPG information server 36 are commonly provided in the server 32 as shown in FIG. 1. Alternatively, both may be interconnected to the network 28 separately from each other. The telecommunications network 28 may advantageously be the Internet, including wired or wireless connections.

The network interface circuit 16 has the communication function of accessing the video/audio distribution server 34 and receiving from the latter a video/audio data stream. The video/audio data may, for example, be of the form encoded in accordance with the MPEG (Moving Picture Experts Group) encoding system. The communication protocol used by the network interface circuit 16 and the EPG information server 36 may, for example, be RTP (Real-Time Transport Protocol).

The network interface circuit 16 has the communicating function of accessing the EPG information server 36 and receiving therefrom EPG data, which is resultant from encoding EPG information, which is in the from of text data. The communication protocol used by the network interface circuit 16 and the EPG information server 36 may, for example, be TCP/IP (Transmission Control Protocol/Internet Protocol).

In the illustrative embodiment, video/audio data and EPG data are allocated to respective keys on a keyboard by means of CRID (Content Reference IDentifier) conforming to the TV-Anytime Forum SP004.

In the STB box 10 of the embodiment, the video/audio reproducer 12 is connected to the network interface circuit 16 and to the display output circuit 14. The video/audio reproducer 12 has the function of decoding data to reproduce a signal representing the decoded data. The video/audio reproducer 12 includes a decoder, not shown, which is responsive to a command 38 provided from the operation panel 22 to read out the encoded EPG information 40 received by the network interface circuit 16 to decode the encoded data. From the decoded data, digital or analog video and audio signals are produced. The video/audio reproducer 12 transfers the resulting video signal 42 to the display output circuit 14.

The display output circuit 14 has the function of selectively outputting the video signal 42, supplied from the video/audio reproducer 12, or the EPG video signal 44 of the program table format, supplied from the display controller 24, or simultaneously outputting both signals 42 and 44. The display output circuit 14 provides the display unit 46 with at least one of the video signal 42 and the EPG video signal 44 as a video signal 47.

The data acquisition controller 18 is connected to the network interface circuit 16, memory 20 and display controller 24. The data acquisition controller 18 has the function of requesting to acquire data and controlling the decoding. The data acquisition controller 18 transmits a download request signal 40 requesting to download EPG information to the EPG information server 36 via the network interface circuit 16. The data acquisition controller 18 decodes EPG information 40 received by the network interface circuit 16 in response to the request signal 40. The data acquisition controller 18 outputs the so decoded EPG data 48 to the memory 20 to save the data therein, while transferring EPG data 50 to the display controller 24.

The operation panel or operation controller 22 is responsive to the input operation or manipulation of the user and transfers commands 38 and 52 corresponding to the user's input operation, to the video/audio reproducer 12 and the display controller 24, respectively. The operation panel 22 may be provided in the STB box 10 itself or outside the STB box 10 in the form of a remote controller or a pointing device such as a mouse.

The display controller 24 has an indicating function and a display control function. The display controller 24 is connected to the display output circuit 14, data acquisition controller 18 and operation panel 22. The display controller 24 is responsive to the command 52 provided from the operation panel 22 to transfer the time zone information for display request to the data acquisition controller 18. The display controller 24 is responsive to the time zone information for display request transferred to accept the EPG information 50, acquired by the data acquisition controller 18, to produce an EPG video signal 44 of the program table format, that is, the program table display data. The display controller 14 then transfers the so generated EPG video signal 44 to the display output circuit 14.

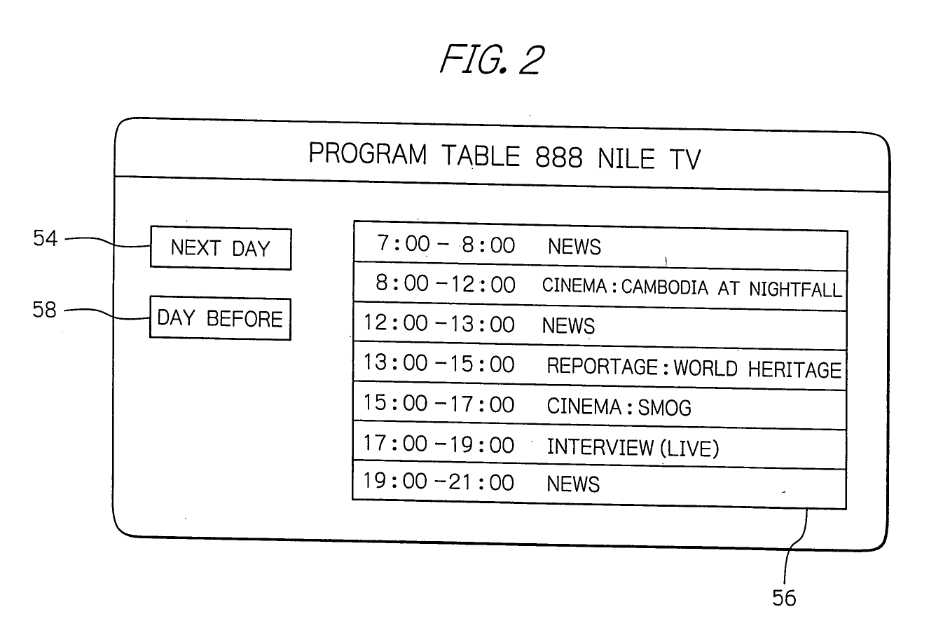

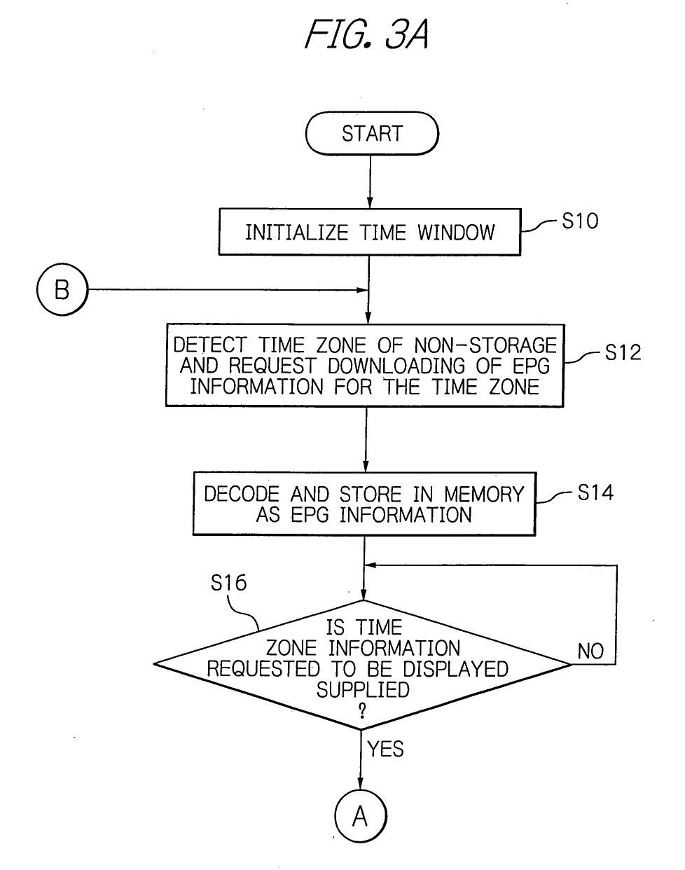

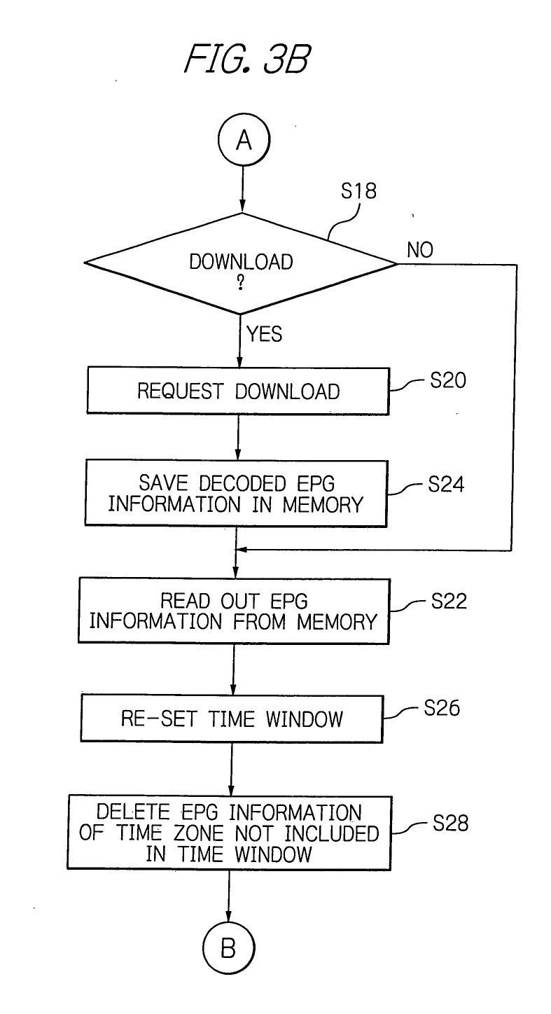

The EPG information display operation of the STB box 10 according to the present invention will now be described with reference to FIGS. 3A and 3B. As seen from FIG. 2, an exemplified broadcast channel is directed to a program schedule table for a TV channel A (888 Nile TV) displayed on the display unit 46.

The data acquisition controller 18 initializes the time window of the channel A, as shown in step S10, FIG. 3A. The time window is a temporal section for holding EPG information of a predetermined time duration from a time point Ws to a time point We, e.g. 120 hours. The initial time window is a time domain for holding the predetermined duration of EPG information, with its start time point Ws corresponding to the starting point of the current program.

The data acquisition controller 18 detects a time domain part or time zone in which no EPG information is stored in the memory 20 in a set time window. The data acquisition controller 18 then requests downloading of EPG information corresponding to this domain part (step S12). In case the time window has been initialized, no EPG information is usually present in the memory 20 for the time zone of the time window. Hence, the data acquisition controller 18 generates a signal 26 requesting downloading EPG information for the entire time domain in the time window. The downloading request signal 26 is transmitted from the network interface circuit 16 to the EPG information server 36. The EPG information server 36 in turn receives the downloading request signal 30 over the network 28. The EPG information server 36 is responsive to the downloading request signal 30 supplied to transmit EPG information of the thus set time window in the form of EPG data 30 to the STB box 10. The network interface circuit 16 receives the EPG data 40 to transfer the EPG data 40 to the data acquisition controller 18.

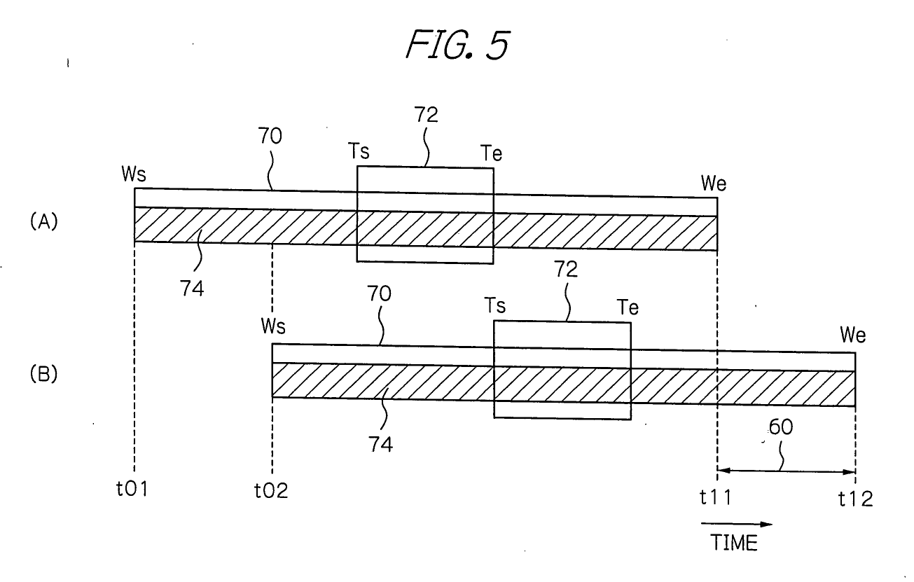

The data acquisition controller 18 then decodes the EPG data 40 to develop the so decoded EPG data as the EPG information of the channel A to save the data in the memory 20 (step S14). After saving the data, the data acquisition controller 18 verifies whether or not the time zone information requested to be displayed has been supplied from the display controller 24 (step S16). If the time zone information requested to be displayed has not been supplied (NO), the data acquisition controller 18 reverts to the step S16 of the processing for decision. If the time zone information requested to be displayed has been supplied (YES), the data acquisition controller moves to a step S18 of processing for decision, FIG. 3B, as indicated by a connection A. The time zone information requested to be displayed corresponds to the section 72 shown in part (B) of FIG. 5.

The time zone information requested to be displayed is directed to the time domain part of EPG information to be actually displayed on the display unit 46 in the form of program table or list. The operation panel 22 is responsive to the ‘next day’ button 54, FIG. 2, clicked or depressed by the user, and transfers the EPG display request command 52 to the display controller 24. Based on the EPG display request command 52, the display controller 24 formulates and develops information 44 on the time zone part requested to be displayed. The time domain part 44 requested to be displayed begins at a time point Ts and terminates at a time point Te. In the time window, the relationship in length or duration of the time domain from Ws to We to the time domain part from Ts to Te satisfies (We−Ws)>(Te−Ts).

When supplied with the time zone information 50 requested to be displayed from the display controller 24, the data acquisition controller 18 verifies whether or not new downloading is requested (step S18). If the new downloading is requested (YES), the memory 20 contains no EPG information of the time domain Ts−Te, specified by the time zone information transferred, and thence new downloading is requested. In this case, the data acquisition controller 18 moves to a step S20 of processing requesting downloading the EPG information. If no downloading is requested (NO), then the STB box 10 moves to a step S22 of processing of reading out the EPG information from the memory 20, because the EPG information as from time point Ts until time point Te has been stored in the memory 20. If no downloading is needed, as in the latter case, the EPG information is read out immediately.

In the processing for requesting the downloading, a request signal is transferred from the data acquisition controller 18 via the network interface circuit 16 to the EPG information server 36, in the same way as described above. The EPG information server 36 receives the downloading request signal 30, over the network 28, and is responsive to the downloading request signal 30 to transmit the EPG information of the set time window in the form of EPG data 30 to the network interface circuit 16 of the STB box 10. The network interface circuit 16 outputs the received EPG data 26 as the EPG data 40 to the data acquisition controller 18. The EPG data may be of binary-encoded data.

The STB box 10 decodes the EPG data 40, supplied by the data acquisition controller 18, and deploys the so decoded data as the EPG information for the channel A to store the so deployed data in the memory 20 (step S24). The EPG information 48, as the time zone information as from the time point Ts until time point Te, is then read out from the memory 20 to the data acquisition controller 18 (step S22). The so read-out EPG information 48 is output to the display controller 24.

The data acquisition controller 18 then sets again, or re-sets, the time window (step S26). The start time point Ws and the end time point We of the re-set time window may, for example, be such that Ws=Ts−48 hours and We=Te+48 hours. The memory 20 deletes the EPG information of the time zone not included in the time window of the so re-set time points Ws to We (step S28).

The data acquisition controller 18 then reverts, via a connection B, to the step S12, FIG. 3A, of processing of detecting a time span in the time domain of the set time window, where no EPG information is stored in the memory 20, and of requesting the downloading of EPG information for that time span. By so doing, the sequence of processing operations is carried out repeatedly.

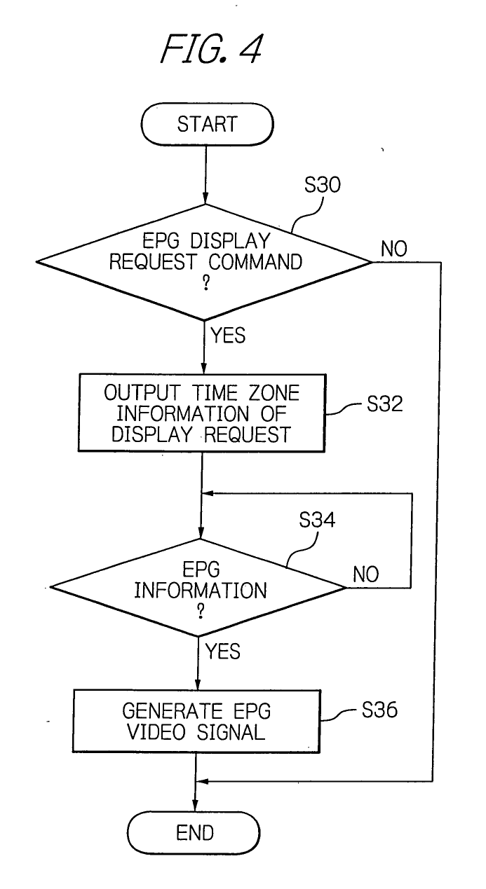

The STB box 10 then processes a variety of interrupts, in response to the manipulations on the operation panel 22. An example of the interrupts is shown in FIG. 4. The display controller 24 verifies, as shown in the figure, whether or not the EPG display request command 52 has been supplied from the operation panel 22 (step S30). In the absence of the EPG display request command 52 (NO), then the control proceeds to terminating the processing. If the EPG display request command 52 has been supplied (YES), the control advances to a step S32 of outputting the time zone information requested to be displayed.

As shown in FIG. 2, the EPG display screen includes the ‘next day’ button 54 and the ‘day before’ button 58 displayed, along with the program table 56. The EPG display request command 52 is generated either by the operator acting on an ‘EPG’ button, not shown, of the operation panel 22, or by the user acting, by a mouse operation, on either the ‘next day’ button 54 or the ‘day before’ button 58 on the display screen. Depending on the contents of the EPG display request command 52, the display controller 24 generates time zone information requested to be displayed. This time zone shows a time span of the EPG information to be displayed on the program table 56. The display controller 24 transfers the so generated time zone information 50 to the data acquisition controller 18 (step S32).

In case the ‘EPG’ button has been acted on, the current time is set to Ts and the time point Te is set so that Te=Ts+24. If the ‘next day’ button 54 has been acted on, the time zone information requested to be displayed is such that, for the current EPG display time domain Ts to Te, the time point Ts=Ts+24 and the time point Te=Te+24, where 24 denotes the hours of one day. If the ‘day before’ button 58 has been acted on, the time domain information requested to be displayed is such that the time point Ts=Ts−24 and the time point Te=Te−24 for the current EPG display time domain Ts to Te.

The display controller 24 then verifies whether or not the EPG information 50 has been supplied from the data acquisition controller 18 (step S34). If the EPG information 50 has not been supplied (NO), the processing for decision is repeated until the EPG information 50 is supplied. That is, processing transfers to the step S34 each time the information is not supplied. If the EPG information 50 has been supplied (YES), the display controller 24 moves to a step S36 of processing of producing the EPG video signal 44.

The display controller 24 then produces the EPG video signal 44 of the program table format and transfers the so produced EPG video signal 44 to the display output circuit 14 (step S36). Thus, when the ‘EPG’ button of the operation panel 22 is acted on, the display output circuit 14 outputs the EPG information 48 of the program table format to the display unit 46. The display unit 46 displays the program table on its display screen as shown in FIG. 2 to terminate the interrupt processing.

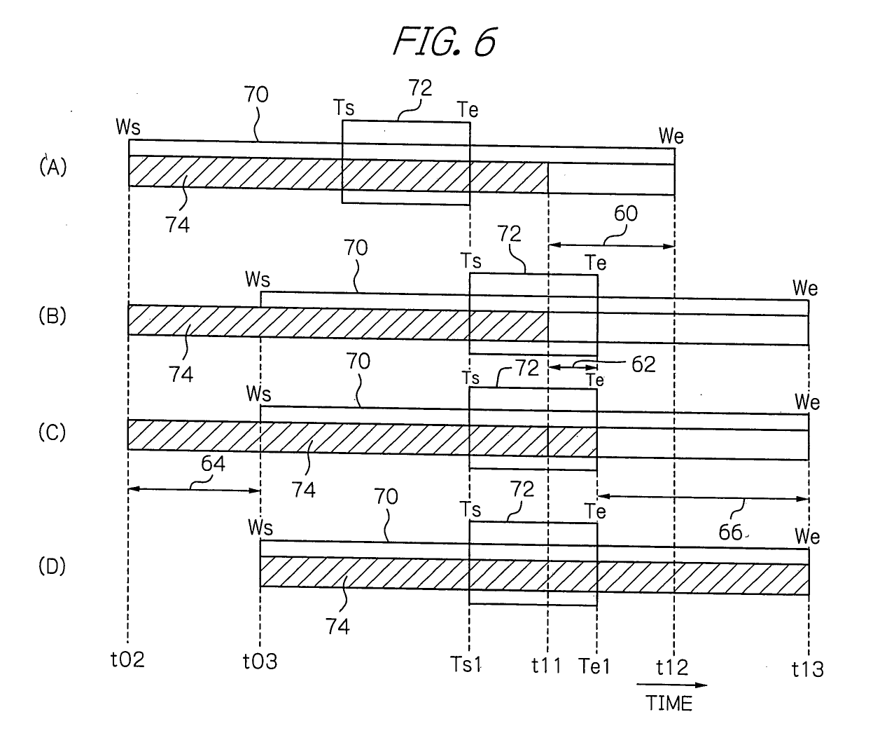

The time window in the STB box 10 will now be briefly described with reference to FIGS. 5 and 6. With the time window 70, shown in FIG. 5, part (A), the start time point Ws is set at a time point t01, while the end time point We is set at a time point t11. In the so set time window 70, a time zone requested to be displayed 72 is shown. The hatched zones 74 indicate the EPG information stored in the memory 20 for the time points concerned.

If the user has clicked the ‘next day’ button 54 of the display screen, the time zone information 50 requested to be displayed is supplied from the display controller 24 to the data acquisition controller 18. The time zone information 50 of the display request indicates a time point Ts=Ts+24 and a time point Te=Te+24. The time point Te in the transferred time zone information 50, requested to be displayed, is well before the end point We of the time window, that is, well before time point t11. Since the EPG information for the time zone Ts to Te of the new display request has already been stored in the memory 20, the downloading, shown in FIG. 3B, is not requested. Hence, the EPG information from time point Ts until time point Te is immediately read out from the memory 20 and transferred to the display controller 24, as a result of which the program table for the time zone Ts to Te of the new display request is displayed on the display unit 46.

If the data acquisition controller 18 re-sets the time window, the start time point Ws and the end time point We of the time window 70 are changed to the time points t02 and t12, respectively, as shown in FIG. 5, part (B). Since the endpoint We is now the time point t12, EPG information 76 for a time span 60 between the time points t11 and t12 is not stored in the memory 20. Thus, the data acquisition controller 18 requests downloading EPG information 76 for the detected time span 60 between the time points t11 and t12.

In the time window, shown in FIG. 6, part (A), the start time point Ws is set at a time point t02 and the end point We is set at a time point t12. A time zone 72 requested to be displayed is included within the time window 70. For the time span 60, no EPG information is stored in the memory 20. In this state, if the user has clicked the ‘next day’ button 54 on the display screen, the time zone information 50, requested to be displayed, is transferred from the display controller 24 to the data acquisition controller 18. The time zone information 50, requested to be displayed, is represented by the relationship of the time point Ts=Ts+24=Ts1 and the time point Te=Te+24=Te1, as shown in FIG. 6, part (B).

As shown in FIG. 6, part (B), not all the EPG information 74 for the time zone Ts1 through Te1 is stored in the memory 20. That is, EPG information for the time zone t11 through Te1 is not stored in the memory 20. Hence, the data acquisition controller 18 requests downloading of that lacking part 62 of EPG information 74. The EPG data 40 for the time zone t11 through Te1 is downloaded from the EPG information server 36 to the data acquisition controller 18. The EPG information 48 for the time domain 62, after decoded, is written in the memory 20, as shown in FIG. 6, part (C). The EPG information 48 from time point Ts1 until time point Te1 is then immediately read out from the memory 20. The EPG information 74 is transferred to the display controller 24 as the EPG information 50. Thus, a program table for the time domain Ts1 to Te1, newly requested to be displayed, will now be displayed on the display unit 46.

The data acquisition controller 18 re-sets the time window. By so doing, the start point Ws and the end point We of the time window 70 are changed from the time point t03 and to the time point t13, respectively, as shown in FIG. 6, part (B).

A time zone 64 of the time points t02 through t03 is outside the time domain of the re-set time window 70, as shown in FIG. 6, part (C). Hence, the EPG information for the time points t02 through t03 is deleted from the memory 20 (step S28). Since the end time point We is now the time point t13, EPG information for a time zone 66 of the time points te1 through t13 is not stored in the memory 20. Thus, the data acquisition controller 18 outputs a request to download EPG information of the time domain 66 of the time points te1 to t13. By this downloading request, the EPG data of the time domain 66 is downloaded from the EPG information server 36 to the data acquisition controller 18. After decoding the EPG data 40, the data acquisition controller 18 writes the EPG data 40 as the EPG information for that zone 66 in the memory 20. Hence, the complete EPG information in the time domain of the re-set time window 70 is stored in its entirety in the memory 20, as shown in FIG. 6, part (D).

In this manner, the STB box 10 causes the EPG information in a time zone in the time window 70, made up of a time span displayed as a program table 56, and time spans temporally ahead and in rear of the displayed time span, to be stored in the memory 20. The STB box then reads the EPG information for the time zone, as requested and specified by the user's manipulation, to generate the EPG video signal 44, which is the program table display data representative of the broadcast program table 56. The STB box 10 then re-sets the time window 70, and downloads the EPG information for a time span, which has become short as a result of the time window re-setting, from the EPG information server 36. The so downloaded EPG information is stored in the memory 20. Hence, the STB box 10 is able to read out from the memory 20 the EPG information for a requested time zone, which has newly been specified by the next user's manipulation, to immediately produce and output the EPG video signal 44. That is, the program table 56, derived from the EPG information of the time zone requested to be displayed by user's manipulation, may quickly be displayed.

Moreover, if not all of the EPG information for the time zone, newly requested to be displayed by the user's manipulation, is prepared in the memory 20, then the STB box 10 causes only such part of the EPG information for the time domain in deficit to be immediately downloaded from the EPG information server 36, such as to provide the EPG information for the time zone requested to be displayed. Hence, the STB box 10 is able to display the program table in a short time, based on the EPG information of the time zone requested to be displayed, even in case the user has acted on the ‘next day’ button 54 in succession.

The present invention is not to be restricted to the particular illustrative embodiment of the STB box 10 described above. The present invention may, of course, be applied to other types of devices for downloading EPG information and displaying the so downloaded EPG information as a programmable, such as a video recorder, e.g. an HDD recorder or a DVD recorder, or a personal computer (PC).

In the above-described embodiment, a program table for one broadcast channel is displayed. However, the present invention may of course be applied to simultaneously displaying program tables for plural broadcast channels. In the embodiment, although EPG information is obtained by downloading EPG data from the EPG information server 36, this again is not restrictive but EPG information may, for example, be extracted from a data signal included in television on-air signals.

As described above, the present invention allows a program table within a time zone as requested by the user to be displayed relatively quickly.

The entire disclosure of Japanese patent application No. 2006-189009 filed on Jul. 10, 2006, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. A program table generator comprising:
a communication circuit for receiving program information of an on-air program from outside;
a memory for saving the program information received by said communication circuit;
an operation controller operative in response to manipulation for designating a time domain representing a request time zone of a program table of the on-air program;
a display controller for reading out the program information for the designated time zone to generate display data of the program table representing the program table of the on-air program; and
a data acquisition controller for setting, after the display data of the program table is generated, a time domain for saving of a predetermined time length including the designated time zone of request, detecting a time span in the time domain for saving for which the program information is lacking in said memory, and acquiring the program information of the detected lacking time span from outside through said communication circuit and saving the acquired program information in said memory.

2. The generator in accordance with claim 1, wherein said data acquisition controller is responsive to designation of the designated request time zone to verify whether or not the program information for the time zone in its entirety has been stored in said memory, and to acquire the program information of the time zone where the program information is lacking from outside via said communication circuit in response to the lack of the program information for the time zone in its entirety in said memory.

3. The generator in accordance with claim 1, wherein said data acquisition controller deletes the program information for time other than the time span indicating the set time domain for saving.

4. The generator in accordance with claim 1, wherein said communication circuit downloads data including the program information from an information device holding the program information;
said data acquisition controller decoding the downloaded data to acquire the program information.

5. A program table generator comprising:
communication means for receiving program information of an on-air program from outside;
storage means for saving the program information received by said communication means;
operation control means operative in response to manipulation for designating a time domain representing a request time zone of a program table of the on-air program;
display control means for reading out the program information for the designated time zone to generate display data of the program table representing the program table of the in-air program; and
data acquisition control means for setting, after the display data of the program table is generated, a time domain for saving of a predetermined time length including the designated time zone of request, detecting a time span in the time domain for saving for which the program information is lacking in said storage means, and acquiring the program information of the detected lacking time span from outside through said communication means and saving the acquired program information in said storage means.

6. A method for generating a program table, comprising:
a first step of receiving program information of an on-air program from outside to display display data of a program table in accordance with the program information;
a second step of saving the program information received in a storage;
a third step of designating a time span indicating a request time zone of the program table in response to manipulation;
a fourth step of reading out the program table saved from the storage for the designated request time zone to generate the display data of the program table;
a fifth step of setting, following said fourth step, a time domain for saving showing a predetermined time length including the designated time zone of request;
a sixth step of detecting a time span in the time domain for saving for which the program information is lacking in the storage; and
a seventh step of acquiring the program information of the detected lacking time span from outside through a communication circuit and saving the acquired program information in the storage.
